(19) United States
(12) Patent Application Publication
(10) Pub. No.: US 2024/0127251 A1
(43) Pub. Date: Apr. 18, 2024

(54) SYSTEMS AND METHODS FOR PREDICTING CASH FLOW

(71) Applicant: Capital One Services, LLC, McLean, VA (US)

(72) Inventor: Anthony J. Ladner, Clarksburg, MD (US)

(21) Appl. No.: 17/967,826

(22) Filed: Oct. 17, 2022

(51) Int. Cl. G06Q 20/40; G06Q 40/02

(52) U.S. Cl. CPC G06Q 20/4016; G06Q 40/025

(57) ABSTRACT

Disclosed embodiments may include a system for predicting cash flow. The system may aggregate transaction information associated with cash inflows and outflows of a user account. The system may generate a GUI displaying current cash inflows and outflows, including cash outflow categories, for the user account. The system may predict, via a trained MLM, a future time period in which the future cash outflows will exceed the future cash inflows associated with the user account. The system may update the GUI to display the future cash inflows and outflows associated with the future time period by rearranging the cash outflow categories in order of predicted use in the future time period. The system may transmit a notification to a user device associated with the user account to reduce cash outflow associated with a cash outflow category associated with a highest predicted use.

The disclosed technology relates to systems and methods for predicting cash flow. Specifically, this disclosed technology relates to aggregating cash inflows and outflows to predict future spending.

### BACKGROUND

Traditional systems and methods for predicting cash flow typically provide for monitoring of user transaction data based on monthly billing cycles. These systems also typically require frequent review by users themselves for budgeting purposes. As such, there are limitations as to these systems being able to provide automated and real-time cash flow evaluation.

Accordingly, there is a need for improved systems and methods for predicting cash flow. Embodiments of the present disclosure are directed to this and other considerations.

### SUMMARY

Disclosed embodiments may include a system for predicting cash flow. The system may include one or more processors, and memory in communication with the one or more processors and storing instructions that, when executed by the one or more processors, are configured to cause the system to provide data monitoring. The system may aggregate first transaction information associated with cash inflows associated with a user account. The system may aggregate second transaction information associated with cash outflows associated with the user account. The system may generate a graphical user interface (GUI) displaying current cash outflows and current cash inflows for the user account, the current cash outflows including one or more cash outflow categories. The system may provide the aggregated first transaction information and the aggregated second transaction information to a machine learning model (MLM). The system may train the MLM to predict future cash inflows and future cash outflows using the aggregated first transaction information and the aggregated second transaction information. The system may predict, via the trained MLM, a future time period in which the future cash outflows will exceed the future cash inflows associated with the user account. The system may update the GUI to display the future cash inflows and the future cash outflows associated with the future time period by rearranging the one or more cash outflow categories in order of predicted use in the future time period. The system may transmit a notification to a user device associated with the user account to reduce cash outflow associated with a cash outflow category associated with a highest predicted use.

Disclosed embodiments may include a system for predicting cash flow. The system may include one or more processors, and memory in communication with the one or more processors and storing instructions that, when executed by the one or more processors, are configured to cause the system to provide data monitoring. The system may aggregate first transaction information associated with cash inflows associated with a user account. The system may aggregate second transaction information associated with cash outflows associated with the user account. The system may provide the aggregated first transaction information and the aggregated second transaction information to an MLM. The system may train the MLM to predict future cash inflows and future cash outflows using the aggregated first transaction information and the aggregated second transaction information. The system may predict, via the trained MLM, a future time period in which the future cash outflows will exceed the future cash inflows associated with the user account. The system may transmit a notification to a user device associated with the user account to reduce cash outflow in the future time period.

Disclosed embodiments may include a method for predicting cash flow. The method may include aggregating first transaction information associated with cash inflows associated with a user account. The method may include aggregating second transaction information associated with cash outflows associated with the user account. The method may include providing the aggregated first transaction information and the aggregated second transaction information to an MLM. The method may include training the MLM to predict future cash inflows and future cash outflows using the aggregated first transaction information and the aggregated second transaction information. The method may include predicting, via the trained MLM, a future time period in which the future cash outflows will exceed the future cash inflows associated with the user account. The method may include transmitting a notification to a user device associated with the user account to reduce cash outflow in the future time period.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for predicting cash flow in accordance with certain embodiments of the disclosed technology.

FIG. 2 is a diagram of an example prediction system used to predict cash flow, according to an example implementation of the disclosed technology.

FIG. 3 is block diagram of an example system used to predict cash flow, according to an example implementation of the disclosed technology.

FIGS. 4A-4E are GUI displays that may be used to provide a user with cash flow predictions, according to example implementations of the disclosed technology.

### DETAILED DESCRIPTION

As traditional systems and methods for predicting cash flow typically provide for monitoring of user transaction data based on monthly billing cycles, it can be challenging for users to have an accurate picture of their current billing cycles. For example, typical monthly billing cycles do not provide transactions that a user conducted within a calendar month, since the user last paid an account bill (e.g., if the user pays off an account balance multiple times per month), or those the user conducted across multiple accounts.

Accordingly, examples of the present disclosure may relate to systems and methods for predicting cash flow. More particularly, the disclosed technology may relate to aggregating cash inflows and outflows across multiple accounts of a user to predict future spending. For example, the disclosed technology may provide for aggregating cash inflows and outflows associated with a user's accounts, predicting future cash inflows and outflows based on the aggregated cash inflows and outflows, and dynamically updating and displaying the future cash inflows and outflows via a GUI based on specific time periods and/or spend categories.

The systems and methods described herein may utilize, in some instances, machine learning models (MLMs), among other computerized techniques, to predict future time periods in which a user's future cash outflows may exceed corresponding future cash inflows. Machine learning models are a unique computer technology that involves training models to complete tasks and make decisions. The present disclosure details providing aggregated cash inflow and outflow information to an MLM, and training the MLM to use that information to make predictions as to how a user's future cash inflows and outflows may compare to one another within certain spend categories and/or within certain future time periods. This, in some examples, may involve using transaction and financial data and a prediction type MLM, applied to predict when a user's future cash outflows, e.g., in certain spend categories, may exceed the user's future cash inflows. Using an MLM in this way may allow the system to provide a real-time and accurate estimation of how a user's financial picture may look at future points. This is a clear advantage and improvement over prior technologies that provide monthly billing cycle information because these technologies may not provide a way to evaluate current transaction information, and/or current transaction information within certain spend categories and/or across multiple accounts. Furthermore, examples of the present disclosure may also improve the speed with which computers can provide future cash inflow and outflow predictions. Overall, the systems and methods disclosed have significant practical applications in the cash flow prediction field because of the noteworthy improvements of future spend estimations, which are important to solving present problems with this technology.

The systems and methods described herein may also utilize, in some instances, graphical user interfaces (GUIs), which are necessarily rooted in computers and technology. Graphical user interfaces are a computer technology that allows for user interaction with computers through touch, pointing devices, or other means. The present disclosure details generating a GUI configured to display cash inflows and outflows associated with multiple user accounts, and dynamically updating the GUI to display future cash inflows and outflows associated with future time periods by rearranging spend categories in order of their predicted use in such future time periods. This, in some examples, may involve the continuous monitoring of user data and future cash inflow and outflow predictions to dynamically change the GUI so that these predictions may be displayed in various formats, such as colors, sizes, layouts, etc., which involves using non-generic computer components. Using a GUI in this way may allow the system to provide cash flow predictions with increased accuracy and usability. This is a clear advantage and improvement over prior technologies that typically provide only periodic updating and displaying of user data. Furthermore, examples of the present disclosure may also improve the speed with which computers can provide such re-formatting and displaying of data. Overall, the systems and methods disclosed have significant practical applications in the cash flow prediction field because of the noteworthy improvements of the real-time generating and displaying of modified GUIs, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

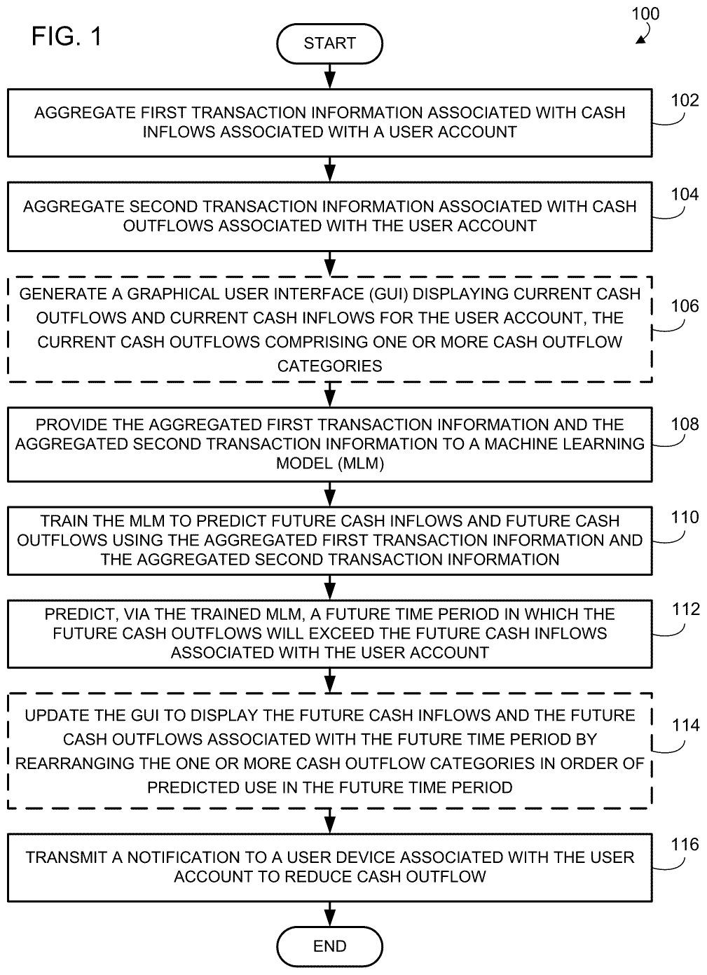

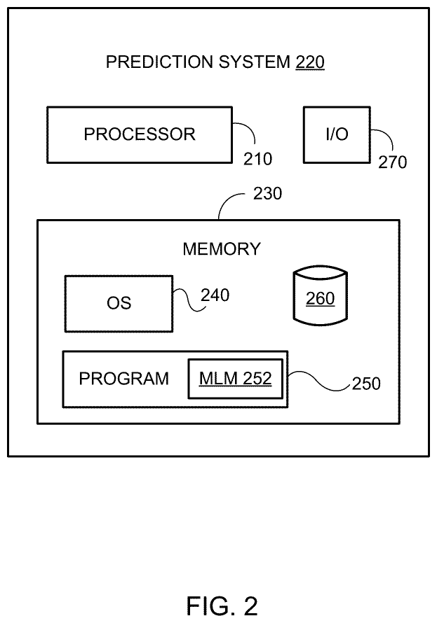

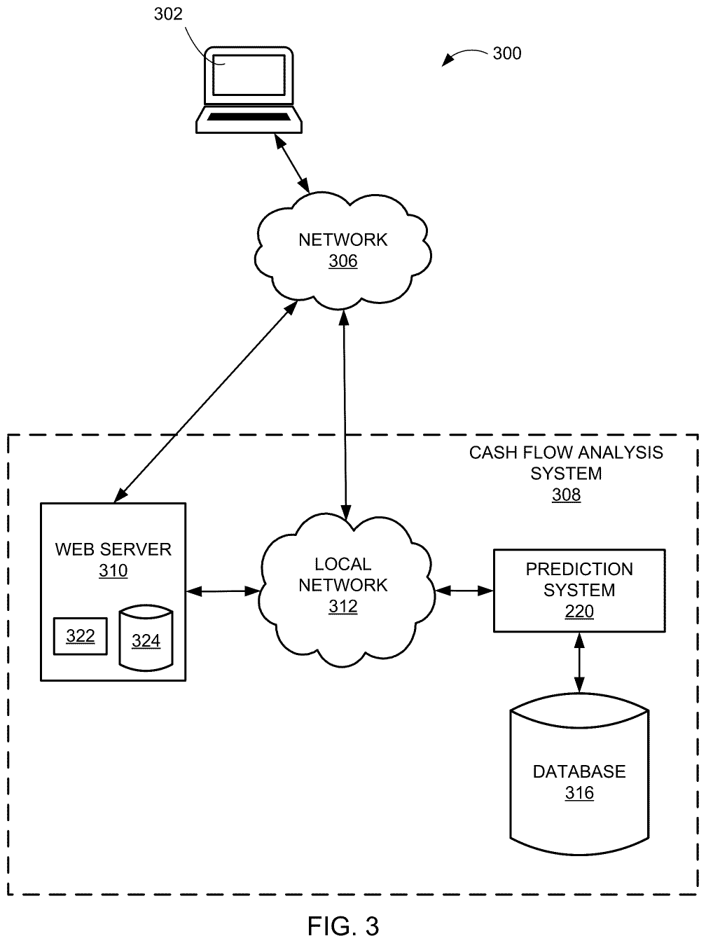

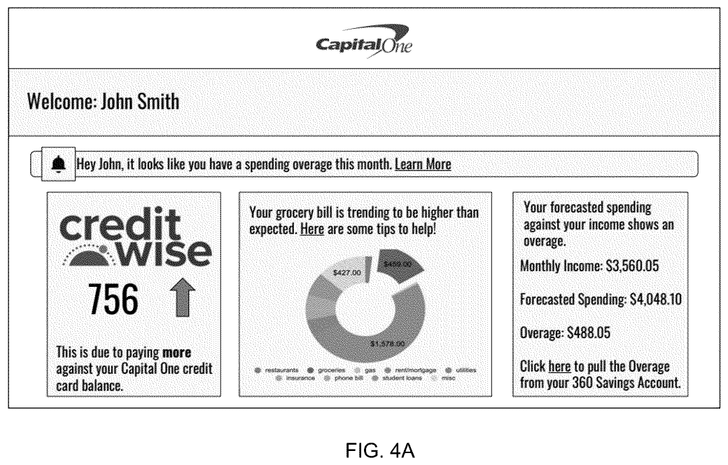

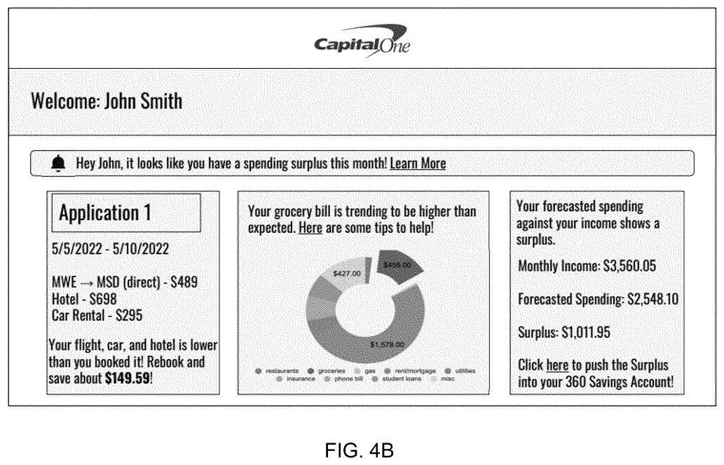

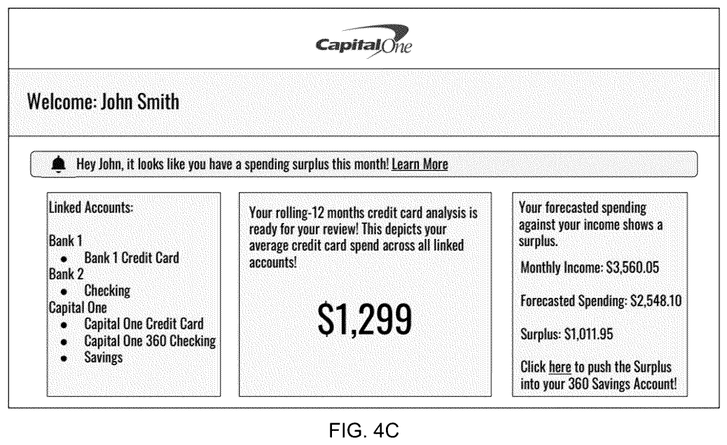

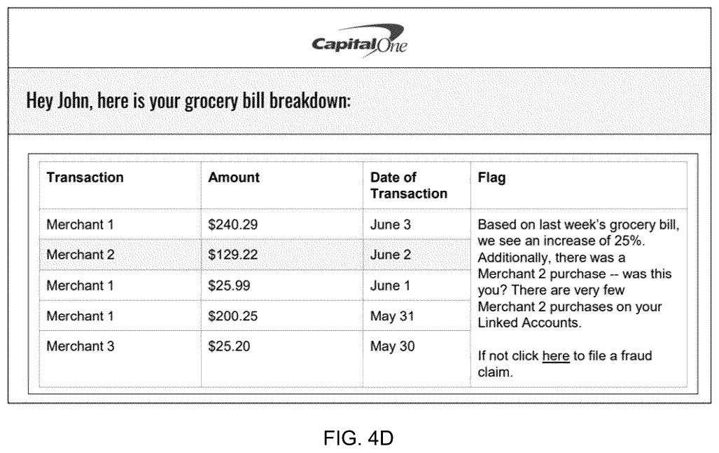

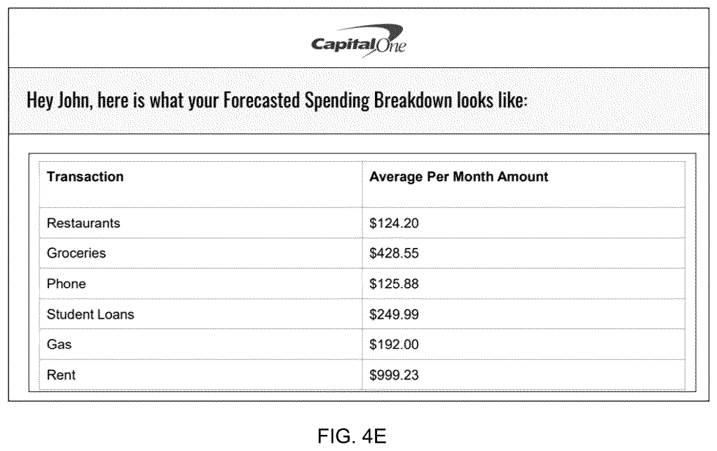

FIG. 1 is a flow diagram illustrating an exemplary method 100 for predicting cash flow, in accordance with certain embodiments of the disclosed technology. The steps of method 100 may be performed by one or more components of the system 300 (e.g., prediction system 220 or web server 310 of cash flow analysis system 308 or user device 302), as described in more detail with respect to FIGS. 2 and 3. FIGS. 4A-4E provide examples of GUI displays that may be used in conjunction with the exemplary method 100, and as such, will be described simultaneously herein.

In block 102 of FIG. 1, the prediction system 220 may aggregate first transaction information associated with cash inflows associated with a user account. For example, the first transaction information may correspond to various sources of income (e.g., employment salary, investment revenue, real estate rental income, rewards, credits, etc.) that flow into a user's one or more accounts. In some embodiments, the one or more accounts may also be operated and/or managed by a single entity, such as an organization that owns and/or operates cash flow analysis system 308, as discussed below with respect to FIGS. 2 and 3.

In block 104 of FIG. 1, the prediction system 220 may aggregate second transaction information associated with cash outflows associated with the user account. For example, the second transaction information may correspond to various sources of spending (e.g., bills, home or rental payments, vehicle payments, loan payments, phone payments, food, groceries, gas, etc.) that flow out of the user's one or more accounts.

In optional block 106 of FIG. 1, the prediction system 220 may generate a GUI displaying current cash outflows and current cash inflows for the user account, the current cash outflows including one or more cash outflow categories. For example, as shown in FIGS. 4A-4C, a GUI may be displayed within a user's account profile, the profile associated with an entity (e.g., a financial organization). The GUI may display the user's cash inflows, for example, in the form of the user's total monthly income (e.g., based on the aggregated first transaction information, as discussed above, and/or an average based on the user's historical spending patterns). The GUI may also display the user's cash outflows based on certain spend or outflow categories, for example, restaurants, groceries, gas, rent/mortgage, utilities, insurance, phone bill, student bills, miscellaneous, etc. (e.g., based on the aggregated second transaction information, as discussed above, and/or from across all of the user's linked accounts, as discussed below). The GUI may be configured to display the user's cash outflows in various formats, such as a pie chart with each segment corresponding to a different spend category (e.g., FIGS. 4A-4B).

As particularly shown in FIGS. 4A-4B, the GUI may be configured to display the difference between the user's estimated monthly income versus forecasted spending. For example, FIG. 4A provides an example of the GUI displaying the user's overage, e.g., how much more the user's forecasted spending amount is in comparison to the user's monthly income. As another example, FIG. 4B provides an example of the GUI displaying the user's surplus, e.g., how much more the user's monthly income is in comparison to the user's forecasted spending. As shown in FIGS. 4A-4B, the GUI may be configured to display a selectable user input object, e.g., a button, link, drop-down menu, etc., such that the user may respectively facilitate the drafting of any displayed overage or the pushing of any displayed surplus from or to one of the user's accounts. As shown in FIGS. 4A-4B, the GUI may be configured to display a notification (e.g., a banner along the top of the GUI display) indicating that the user may have either a spending overage or a surplus for the current month. The GUI may be configured to display a selectable user input object such that the user may obtain additional information on what the notification means and what options the user may have with respect to handling the overage and/or surplus (e.g., a “Learn More” link in the notification banner).

In some embodiments, the prediction system 220 may be configured to provide the user with budgeting assistance, with the assistance displayed via the GUI. For example, as particularly shown in FIGS. 4A-4B, in addition to categorizing the user's cash outflows based on spending categories, as discussed above, the GUI may be configured to display a selectable user input object such that the user may obtain assistance on how to bring down certain categories of spending, e.g., a notification that reads “Here are some tips to help!” including a link to a budgeting application or article.

In some embodiments, as shown in FIGS. 4A-4B, the GUI may be configured to provide a link between the user's account and one or more external applications that may further assist a user with budgeting or managing the user's spending. For example, as shown in FIG. 4A, the GUI may be configured to display a link to an application configured to predict the user's current credit score (e.g., CreditWise® through Capital One®). The prediction system 220 may be configured to continuously receive data from the credit scoring application, and transmit the data to the user via the GUI such that the GUI may dynamically display the user's credit score. Further, the GUI may be configured to display additional information associated with a reasoning behind why the user's credit score may have increased or decreased. As another example, as shown in FIG. 4B, the GUI may be configured to display a link to an application (e.g., Application 1) configured to provide the user with travel booking savings assistance. For example, prediction system 220 may be configured to evaluate the user's transaction information to identify booked travel reservations, e.g., a flight, hotel, car rental, etc. The prediction system 220 may be configured to search (e.g., via a web crawler) various reservation booking websites to determine whether the same reservations the user already made may now be lower in price. Upon making such determination, the prediction system 220 may cause the GUI to display a notification to the user indicating that the user may be able to save a certain amount of money if the user rebooks the same reservations.

In some embodiments, as shown in FIG. 4C, the GUI may be configured to display a listing of one or more banks that the user has linked to the user's account or profile (e.g., Bank 1, Bank 2, etc.). The GUI may be configured to display one or more specific accounts (e.g., account types) that the user has with each of the linked banks. These banks and/or accounts may be linked to the user's account or profile based on permissions received from the other banks to retrieve transaction information associated with those applicable accounts associated with the user. The prediction system 220 may be configured to evaluate all transaction data across the user's various linked accounts to determine larger scale or longer term spending patterns. For example, the prediction system 220 may be configured to determine the user's average credit card spend across all linked accounts on a rolling 12-month basis, which the prediction system 220 may then use to estimate the user's forecasted spending, as discussed above. The GUI may be configured to dynamically display this information to the user as it gets continuously updated by the prediction system 220.

In some embodiments, as particularly shown in FIG. 4D, the GUI may be configured to display a breakdown of the user's spending across merchants within a particular spending category. For example, the GUI may be configured to display a breakdown of all merchants that fall under the “grocery bill” category, along with transaction information (e.g., merchant name, transaction date, transaction amount, etc.) associated with each of the user's grocery transactions over a period of time. The GUI may be further configured to display additional information to aid the user in evaluating the user's purchases within this spend category. For example, as shown in FIG. 4D, the GUI may be configured to display a notification or flag indicating that the user's grocery spending appears to have increased by a certain percent over a period of time. As another example, the GUI may be configured to display a notification or flag indicating that a specific transaction associated with a specific merchant may be fraudulent based on the user's historical transaction information corresponding to the specific merchant. For example, if the user has not shopped at Aldi for a predefined period of time, the GUI may be configured to flag an Aldi purchase to the user such that the user can ensure the purchase is not fraudulent. The GUI may be configured to display a selectable user input object to enable the user to, for example, file a fraud claim should the user believe this specific transaction with the specific merchant appears fraudulent.

In some embodiments, as particularly shown in FIG. 4E, the GUI may be configured to display a breakdown of the user's forecasted spending across various spend categories. For example, the GUI may be configured to display a breakdown of the user's forecasted monthly spending between going out to eat, groceries, phone expenses (e.g., bill payment), loans, gas, rent, and the like. The prediction system 220 may use the breakdown of forecasted monthly spending to generate the user's overall forecasted spending number, as discussed above. The prediction system 220 may be configured to make such future spending predictions via an MLM, as further discussed below, such that they may be displayed to a user via the GUI.

In block 108 of FIG. 1, the prediction system 220 may provide the aggregated first transaction information and the aggregated second transaction information to an MLM. The MLM may be a predictive type of model configured to use the aggregated transaction information to predict future spending, as further discussed below.

In block 110 of FIG. 1, the prediction system 220 may train the MLM to predict future cash inflows and future cash outflows using the aggregated first transaction information and the aggregated second transaction information. For example, the MLM may be trained to evaluate the types, amounts, sources, etc. of cash inflows and outflows for a user to make determinations as to how the user may generate income and/or spend money in the future. For example, the MLM may predict that a user may continue to shop at merchants that show up frequently within the user's transaction information. As another example, the MLM may predict that when a transaction on a real estate property is made, the user's historical cash flows directed toward rental payments may change to mortgage payments.

In block 112 of FIG. 1, the prediction system 220 may predict, via the trained MLM, a future time period in which the future cash outflows will exceed the future cash inflows associated with the user account. For example, as discussed herein, the trained MLM may be configured to estimate a user's future cash inflows and outflows, and accordingly, may be configured to use those estimations to determine a future period of time (e.g., days, months, years, etc.) when the user may be spending more than the user is bringing in.

In optional block 114 of FIG. 1, the prediction system 220 may update the GUI to display the future cash inflows and the future cash outflows associated with the future time period by rearranging the one or more cash outflow categories in order of predicted use in the future time period. For example, as discussed herein, the prediction system 220 may be configured to utilize a MLM trained to utilize the aggregated first and second transaction information to make future predictions as to how the user may spend money. Based on the model's predictions, the prediction system 220 may be configured to cause the GUI to display the future cash inflows and outflows based in order from highest spend category to lower spend category, or vice versa.

In block 116 of FIG. 1, the prediction system 220 may transmit a notification to a user device associated with the user account to reduce cash outflow associated with a cash outflow category associated with a highest predicted use. For example, the prediction system 220 may be configured to cause the GUI to display a banner or flag indicating which category has the highest predicted future spend. As another example, the prediction system may be configured to transmit such notification to the user via various other means, for example, a push-notification to a user device (e.g., a mobile phone), an email, an in-application notification, and the like.

FIG. 2 is a block diagram of an example prediction system 220 used to predict cash flow, according to an example implementation of the disclosed technology. According to some embodiments, the user device 302 and web server 310, as depicted in FIG. 3 and described below, may have a similar structure and components that are similar to those described with respect to example prediction system 220 shown in FIG. 2. As shown, the example prediction system 220 may include a processor 210, an input/output (I/O) device 270, a memory 230 containing an operating system (OS) 240 and a program 250. In some embodiments, program 250 may include an MLM 252 that may be trained, for example, to predict future cash inflows and outflows across multiple user accounts, within certain spend categories, and/or within certain future time periods. In certain implementations, MLM 252 may issue commands in response to processing an event, in accordance with a model that may be continuously or intermittently updated. Moreover, processor 210 may execute one or more programs (such as via a rules-based platform or the trained MLM 252), that, when executed, perform functions related to disclosed embodiments.

In certain example implementations, the prediction system 220 may be a single server or may be configured as a distributed computer system including multiple servers or computers that interoperate to perform one or more of the processes and functionalities associated with the disclosed embodiments. In some embodiments prediction system 220 may be one or more servers from a serverless or scaling server system. In some embodiments, the prediction system 220 may further include a peripheral interface, a transceiver, a mobile network interface in communication with the processor 210, a bus configured to facilitate communication between the various components of the prediction system 220, and a power source configured to power one or more components of the prediction system 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 210 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 210 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 210 may be a single core processor that is configured with virtual processing technologies. In certain embodiments, the processor 210 may use logical processors to simultaneously execute and control multiple processes. The processor 210 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the prediction system 220 may include one or more storage devices configured to store information used by the processor 310 (or other components) to perform certain functions related to the disclosed embodiments. In one example, the prediction system 220 may include the memory 230 that includes instructions to enable the processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The prediction system 220 may include a memory 230 that includes instructions that, when executed by the processor 210, perform one or more processes consistent with the functionalities disclosed herein. Methods, systems, and articles of manufacture consistent with disclosed embodiments are not limited to separate programs or computers configured to perform dedicated tasks. For example, the prediction system 220 may include the memory 230 that may include one or more programs 250 to perform one or more functions of the disclosed embodiments. For example, in some embodiments, the prediction system 220 may additionally manage dialogue and/or other interactions with the customer via a program 250.

The processor 210 may execute one or more programs 250 located remotely from the prediction system 220. For example, the prediction system 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 210, perform one or more processes consistent with the disclosed embodiments. In some embodiments, the memory 230 may include a data review system database 360 for storing related data to enable the prediction system 220 to perform one or more of the processes and functionalities associated with the disclosed embodiments.

The prediction system database 260 may include stored data relating to status data (e.g., average session duration data, location data, idle time between sessions, and/or average idle time between sessions) and historical status data. According to some embodiments, the functions provided by the prediction system database 260 may also be provided by a database that is external to the prediction system 220, such as the database 316 as shown in FIG. 3.

The prediction system 220 may also be communicatively connected to one or more memory devices (e.g., databases) locally or through a network. The remote memory devices may be configured to store information and may be accessed and/or managed by the prediction system 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The prediction system 220 may also include one or more I/O devices 270 that may comprise one or more interfaces for receiving signals or input from devices and providing signals or output to one or more devices that allow data to be received and/or transmitted by the prediction system 220. For example, the prediction system 220 may include interface components, which may provide interfaces to one or more input devices, such as one or more keyboards, mouse devices, touch screens, track pads, trackballs, scroll wheels, digital cameras, microphones, sensors, and the like, that enable the prediction system 220 to receive data from a user (such as, for example, via the user device 302).

In examples of the disclosed technology, the prediction system 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The prediction system 220 may contain programs that train, implement, store, receive, retrieve, and/or transmit one or more MLMs. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, decision tree, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The prediction system 220 may be configured to adjust model parameters during training. Model parameters may include weights, coefficients, offsets, or the like. Training may be supervised or unsupervised.

The prediction system 220 may be configured to train MLMs by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The prediction system 220 may be configured to optimize statistical models using known optimization techniques.

Furthermore, the prediction system 220 may include programs configured to retrieve, store, and/or analyze properties of data models and datasets. For example, prediction system 220 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The prediction system 220 may include algorithms to determine a data type, key-value pairs, row-column data structure, statistical distributions of information such as keys or values, or other property of a data schema may be configured to return a statistical profile of a dataset (e.g., using a data-profiling model). The prediction system 220 may be configured to implement univariate and multivariate statistical methods. The prediction system 220 may include a regression model, a Bayesian model, a statistical model, a linear discriminant analysis model, or other classification model configured to determine one or more descriptive metrics of a dataset. For example, prediction system 220 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The prediction system 220 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, prediction system 220 may be configured to generate a similarity metric representing a measure of similarity between data in a dataset. A similarity metric may be based on a correlation, covariance matrix, a variance, a frequency of overlapping values, or other measure of statistical similarity.

The prediction system 220 may be configured to generate a similarity metric based on data model output, including data model output representing a property of the data model. For example, prediction system 220 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The prediction system 220 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The prediction system 220 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, prediction system 220 is configured to generate and/or train a classification model to classify a dataset, consistent with disclosed embodiments.

The prediction system 220 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the data review system may analyze information applying machine-learning methods.

While the prediction system 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the prediction system 220 may include a greater or lesser number of components than those illustrated.

FIG. 3 is a block diagram of an example system that may be used to view and interact with cash flow analysis system 308, according to an example implementation of the disclosed technology. The components and arrangements shown in FIG. 3 are not intended to limit the disclosed embodiments as the components used to implement the disclosed processes and features may vary. As shown, cash flow analysis system 308 may interact with a user device 302 via a network 306. In certain example implementations, the cash flow analysis system 308 may include a local network 312, a prediction system 220, a web server 310, and a database 316.

In some embodiments, a user may operate the user device 302. The user device 302 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 306 and ultimately communicating with one or more components of the cash flow analysis system 308. In some embodiments, the user device 302 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the cash flow analysis system 308. According to some embodiments, the user device 302 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The prediction system 220 may include programs (scripts, functions, algorithms) to configure data for visualizations and provide visualizations of datasets and data models on the user device 302. This may include programs to generate graphs and display graphs. The prediction system 220 may include programs to generate histograms, scatter plots, time series, or the like on the user device 402. The prediction system 220 may also be configured to display properties of data models and data model training results including, for example, architecture, loss functions, cross entropy, activation function values, embedding layer structure and/or outputs, convolution results, node outputs, or the like on the user device 302.

The network 306 may be of any suitable type, including individual connections via the internet such as cellular or WiFi™ networks. In some embodiments, the network 306 may connect terminals, services, and mobile devices using direct connections such as RFID, NFC, Bluetooth™ BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 306 may include any type of computer networking arrangement used to exchange data. For example, the network 306 may be the Internet, a private data network, virtual private network (VPN) using a public network, and/or other suitable connection(s) that enable(s) components in the system 300 environment to send and receive information between the components of the system 300. The network 306 may also include a PSTN and/or a wireless network.

The cash flow analysis system 308 may be associated with and optionally controlled by one or more entities such as a business, corporation, individual, partnership, or any other entity that provides one or more of goods, services, and consultations to individuals such as customers. In some embodiments, the cash flow analysis system 308 may be controlled by a third party on behalf of another business, corporation, individual, partnership. The cash flow analysis system 308 may include one or more servers and computer systems for performing one or more functions associated with products and/or services that the organization provides.

Web server 310 may include a computer system configured to generate and provide one or more websites accessible to customers, as well as any other individuals involved in access cash flow analysis system 308's normal operations. Web server 310 may include a computer system configured to receive communications from user device 302 via for example, a mobile application, a chat program, an instant messaging program, a voice-to-text program, an SMS message, email, or any other type or format of written or electronic communication. Web server 310 may have one or more processors 322 and one or more web server databases 324, which may be any suitable repository of website data. Information stored in web server 310 may be accessed (e.g., retrieved, updated, and added to) via local network 312 and/or network 306 by one or more devices or systems of system 300. In some embodiments, web server 310 may host websites or applications that may be accessed by the user device 302. For example, web server 310 may host a financial service provider website that a user device may access by providing an attempted login that are authenticated by the prediction system 220. According to some embodiments, web server 310 may include software tools, similar to those described with respect to user device 302 above, that may allow web server 310 to obtain network identification data from user device 302. The web server may also be hosted by an online provider of website hosting, networking, cloud, or backup services, such as Microsoft Azure™ or Amazon Web Services™.

The local network 312 may include any type of computer networking arrangement used to exchange data in a localized area, such as WiFi™, Bluetooth™, Ethernet, and other suitable network connections that enable components of the cash flow analysis system 308 to interact with one another and to connect to the network 306 for interacting with components in the system 300 environment. In some embodiments, the local network 312 may include an interface for communicating with or linking to the network 306. In other embodiments, certain components of the cash flow analysis system 308 may communicate via the network 306, without a separate local network 306.

The cash flow analysis system 308 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 302 may be able to access cash flow analysis system 308 using the cloud computing environment. User device 302 may be able to access cash flow analysis system 308 using specialized software. The cloud computing environment may eliminate the need to install specialized software on user device 302.

In accordance with certain example implementations of the disclosed technology, the cash flow analysis system 308 may include one or more computer systems configured to compile data from a plurality of sources the prediction system 220, web server 310, and/or the database 316. The prediction system 220 may correlate compiled data, analyze the compiled data, arrange the compiled data, generate derived data based on the compiled data, and store the compiled and derived data in a database such as the database 316. According to some embodiments, the database 316 may be a database associated with an organization and/or a related entity that stores a variety of information relating to customers, transactions, ATM, and business operations. The database 316 may also serve as a back-up storage device and may contain data and information that is also stored on, for example, database 260, as discussed with reference to FIG. 2.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### Example Use Case

The following example use case describes an example of a typical user flow pattern. This section is intended solely for explanatory purposes and not in limitation.

In one example, a user may be a customer of a financial institution. The financial institution may own and/or operate a system used for predicting cash flow (e.g., cash flow analysis system 308). The system may be configured to aggregate transaction information associated with the user's cash inflows and outflows. For example, the customer may link a variety of accounts through the financial institution and one or more additional financial institutions to the user's account or profile such that the financial institution may evaluate the customer's cash inflows and outflows across different account sources and types. The system may generate a GUI for display within the customer's account such that any evaluations and/or predictions made by the system can be dynamically displayed to the customer.

The system may provide the customer's aggregated transaction information to an MLM and use the information to train the MLM how to predict the customer's future cash inflows and outflows based on certain time periods and/or within certain spend categories. The MLM may learn how to make sure predictions by evaluating, for example, what sources of income the customer has historically had, how the customer has historically spent his/her money, from what merchants the customer has historically purchased items, and the like. Based on the MLM's predictions, the system may continuously update the GUI to display the customer's predicted future cash flows within certain future time periods, for example, the following month or on a rolling annual cycle. The system may continuously update the GUI to display the customer's predicted spend categories in order from most to least predicted use. Finally, the system may also be configured to transmit a form of notification to the user, for example, a pop-up banner within a GUI of the customer's account.

In some examples, disclosed systems or methods may involve one or more of the following clauses:

Clause 1: A system for predicting cash flow, the system comprising: one or more processors; and a memory in communication with the one or more processors and storing instructions that, when executed by the one or more processors, are configured to cause the system to: aggregate first transaction information associated with cash inflows associated with a user account; aggregate second transaction information associated with cash outflows associated with the user account; generate a graphical user interface (GUI) displaying current cash outflows and current cash inflows for the user account, the current cash outflows comprising one or more cash outflow categories; provide the aggregated first transaction information and the aggregated second transaction information to a machine learning model (MLM); train the MLM to predict future cash inflows and future cash outflows using the aggregated first transaction information and the aggregated second transaction information; predict, via the trained MLM, a future time period in which the future cash outflows will exceed the future cash inflows associated with the user account; update the GUI to display the future cash inflows and the future cash outflows associated with the future time period by rearranging the one or more cash outflow categories in order of predicted use in the future time period; and transmit a notification to a user device associated with the user account to reduce cash outflow associated with a cash outflow category associated with a highest predicted use.

Clause 2: The system of clause 1, wherein the MLM comprises an autoregressive integrated moving average (ARIMA) model.

Clause 3: The system of clause 1, wherein the MLM comprises a neural network selected from a long-short term network, a convolutional neural network, a multilayer perceptron, a temporal fusion transformer, or combinations thereof.

Clause 4: The system of clause 1, wherein the one or more cash outflow categories comprise at least one periodic cash outflow category and at least one non-periodic cash outflow category.

Clause 5: The system of clause 4, wherein the instructions are further configured to cause the system to: provide a fraud alert to the user device responsive to identifying a transaction associated with the at least one non-periodic cash outflow category causing the current cash outflows to exceed the current cash inflows.

Clause 6: The system of clause 1, wherein the aggregated first transaction information comprises a plurality of merchant category codes, each of the merchant category codes of the plurality of merchant category codes associated with a respective transaction of the aggregated first transaction information.

Clause 7: The system of clause 1, wherein the GUI further comprises a credit ratio associated with the current cash inflows and the current cash outflows.

Clause 8: The system of clause 1, wherein the updated GUI further comprises a credit ratio associated with the future cash inflows and the future cash outflows.

Clause 9: A system for predicting cash flow, the system comprising: one or more processors; and a memory in communication with the one or more processors and storing instructions that, when executed by the one or more processors, are configured to cause the system to: aggregate first transaction information associated with cash inflows associated with a user account; aggregate second transaction information associated with cash outflows associated with the user account; provide the aggregated first transaction information and the aggregated second transaction information to a machine learning model (MLM); train the MLM to predict future cash inflows and future cash outflows using the aggregated first transaction information and the aggregated second transaction information; predict, via the trained MLM, a future time period in which the future cash outflows will exceed the future cash inflows associated with the user account; and transmit a notification to a user device associated with the user account to reduce cash outflow in the future time period.

Clause 10: The system of clause 9, wherein the instructions are further configured to cause the system to: generate a graphical user interface (GUI) displaying current cash outflows and current cash inflows for the user account, the current cash outflows comprising one or more cash outflow categories; and responsive to predicting the future time period, update the GUI to display the future cash inflows and the future cash outflows associated with the future time period by rearranging the one or more cash outflow categories in order of predicted use in the future time period.

Clause 11: The system of clause 10, wherein the notification further comprises a cash outflow category associated with a highest predicted use.

Clause 12: The system of clause 10, wherein the one or more cash outflow categories comprise at least one periodic cash outflow category and at least one non-periodic cash outflow category.

Clause 13: The system of clause 12, wherein the instructions are further configured to cause the system to: provide a fraud alert to the user device responsive to identifying a transaction associated with the at least one non-periodic cash outflow category causing the current cash outflows to exceed the current cash inflows.

Clause 14: The system of clause 9, wherein the MLM comprises an autoregressive integrated moving average (ARIMA) model.

Clause 15: The system of clause 9, wherein the MLM comprises a neural network selected from a long-short term network, a convolutional neural network, a multilayer perceptron, a temporal fusion transformer, or combinations thereof.

Clause 16: A computer implemented method for predicting cash flow, the method comprising: aggregating first transaction information associated with cash inflows associated with a user account; aggregating second transaction information associated with cash outflows associated with the user account; providing the aggregated first transaction information and the aggregated second transaction information to a machine learning model (MLM); training the MLM to predict future cash inflows and future cash outflows using the aggregated first transaction information and the aggregated second transaction information; predicting, via the trained MLM, a future time period in which the future cash outflows will exceed the future cash inflows associated with the user account; and transmitting a notification to a user device associated with the user account to reduce cash outflow in the future time period.

Clause 17: The method of clause 16, further comprising: generating a graphical user interface (GUI) displaying current cash outflows and current cash inflows for the user account, the current cash outflows comprising one or more cash outflow categories; and responsive to predicting the future time period, updating the GUI to display the future cash inflows and the future cash outflows associated with the future time period by rearranging the one or more cash outflow categories in order of predicted use in the future time period.

Clause 18: The method of clause 17, wherein the notification further comprises a cash outflow category associated with a highest predicted use.

Clause 19: The method of clause 16, wherein the MLM comprises an autoregressive integrated moving average (ARIMA) model.

Clause 20: The method of clause 16, wherein the MLM comprises a neural network selected from a long-short term network, a convolutional neural network, a multilayer perceptron, a temporal fusion transformer, or combinations thereof.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for predicting cash flow, the system comprising:
one or more processors; and
a memory in communication with the one or more processors and storing instructions that, when executed by the one or more processors, are configured to cause the system to:
aggregate first transaction information associated with cash inflows associated with a user account;
aggregate second transaction information associated with cash outflows associated with the user account;
generate a graphical user interface (GUI) displaying current cash outflows and current cash inflows for the user account, the current cash outflows comprising one or more cash outflow categories;
provide the aggregated first transaction information and the aggregated second transaction information to a machine learning model (MLM);
train the MLM to predict future cash inflows and future cash outflows using the aggregated first transaction information and the aggregated second transaction information;
predict, via the trained MLM, a future time period in which the future cash outflows will exceed the future cash inflows associated with the user account;
update the GUI to display the future cash inflows and the future cash outflows associated with the future time period by rearranging the one or more cash outflow categories in order of predicted use in the future time period; and
transmit a notification to a user device associated with the user account to reduce cash outflow associated with a cash outflow category associated with a highest predicted use.

2. The system of claim 1, wherein the MLM comprises an autoregressive integrated moving average (ARIMA) model.

3. The system of claim 1, wherein the MLM comprises a neural network selected from a long-short term network, a convolutional neural network, a multilayer perceptron, a temporal fusion transformer, or combinations thereof.

4. The system of claim 1, wherein the one or more cash outflow categories comprise at least one periodic cash outflow category and at least one non-periodic cash outflow category.

5. The system of claim 4, wherein the instructions are further configured to cause the system to:
provide a fraud alert to the user device responsive to identifying a transaction associated with the at least one non-periodic cash outflow category causing the current cash outflows to exceed the current cash inflows.

6. The system of claim 1, wherein the aggregated first transaction information comprises a plurality of merchant category codes, each of the merchant category codes of the plurality of merchant category codes associated with a respective transaction of the aggregated first transaction information.

7. The system of claim 1, wherein the GUI further comprises a credit ratio associated with the current cash inflows and the current cash outflows.

8. The system of claim 1, wherein the updated GUI further comprises a credit ratio associated with the future cash inflows and the future cash outflows.

9. A system for predicting cash flow, the system comprising:
one or more processors; and
a memory in communication with the one or more processors and storing instructions that, when executed by the one or more processors, are configured to cause the system to:
aggregate first transaction information associated with cash inflows associated with a user account;
aggregate second transaction information associated with cash outflows associated with the user account;
provide the aggregated first transaction information and the aggregated second transaction information to a machine learning model (MLM);
train the MLM to predict future cash inflows and future cash outflows using the aggregated first transaction information and the aggregated second transaction information;
predict, via the trained MLM, a future time period in which the future cash outflows will exceed the future cash inflows associated with the user account; and
transmit a notification to a user device associated with the user account to reduce cash outflow in the future time period.

10. The system of claim 9, wherein the instructions are further configured to cause the system to:
generate a graphical user interface (GUI) displaying current cash outflows and current cash inflows for the user account, the current cash outflows comprising one or more cash outflow categories; and
responsive to predicting the future time period, update the GUI to display the future cash inflows and the future cash outflows associated with the future time period by rearranging the one or more cash outflow categories in order of predicted use in the future time period.

11. The system of claim 10, wherein the notification further comprises a cash outflow category associated with a highest predicted use.

12. The system of claim 10, wherein the one or more cash outflow categories comprise at least one periodic cash outflow category and at least one non-periodic cash outflow category.

13. The system of claim 12, wherein the instructions are further configured to cause the system to:
provide a fraud alert to the user device responsive to identifying a transaction associated with the at least one non-periodic cash outflow category causing the current cash outflows to exceed the current cash inflows.

14. The system of claim 9, wherein the MLM comprises an autoregressive integrated moving average (ARIMA) model.

15. The system of claim 9, wherein the MLM comprises a neural network selected from a long-short term network, a convolutional neural network, a multilayer perceptron, a temporal fusion transformer, or combinations thereof.

16. A computer implemented method for predicting cash flow, the method comprising:
aggregating first transaction information associated with cash inflows associated with a user account;
aggregating second transaction information associated with cash outflows associated with the user account;
providing the aggregated first transaction information and the aggregated second transaction information to a machine learning model (MLM);
training the MLM to predict future cash inflows and future cash outflows using the aggregated first transaction information and the aggregated second transaction information;
predicting, via the trained MLM, a future time period in which the future cash outflows will exceed the future cash inflows associated with the user account; and
transmitting a notification to a user device associated with the user account to reduce cash outflow in the future time period.

17. The method of claim 16, further comprising:
generating a graphical user interface (GUI) displaying current cash outflows and current cash inflows for the user account, the current cash outflows comprising one or more cash outflow categories; and
responsive to predicting the future time period, updating the GUI to display the future cash inflows and the future cash outflows associated with the future time period by rearranging the one or more cash outflow categories in order of predicted use in the future time period.

18. The method of claim 17, wherein the notification further comprises a cash outflow category associated with a highest predicted use.

19. The method of claim 16, wherein the MLM comprises an autoregressive integrated moving average (ARIMA) model.

20. The method of claim 16, wherein the MLM comprises a neural network selected from a long-short term network, a convolutional neural network, a multilayer perceptron, a temporal fusion transformer, or combinations thereof.
